(19) United States
(12) Patent Application Publication
(10) Pub. No.: US 2019/0316064 A1
(43) Pub. Date: Oct. 17, 2019

(54) METHODS AND COMPOSITIONS FOR CLEANING POLYMERIZED RESIDUE

(71) Applicant: Ecolab USA Inc., St. Paul, MN (US)

(72) Inventors: Mark Raymond Altier, Mendota Heights, MN (US); John Wilhelm Bolduc, Inver Grove Heights, MN (US); Ashish Dhawan, Naperville, IL (US)

(21) Appl. No.: 16/382,920

(22) Filed: Apr. 12, 2019

Related U.S. Application Data
(60) Provisional application No. 62/657,192, filed on Apr. 13, 2018.

(51) Int. Cl. C11D 3/43; C11D 3/30; C11D 3/04; C11D 3/20; C11D 3/33; C11D 1/22; C11D 11/00

(52) U.S. Cl. CPC C11D 3/43; C11D 3/30; C11D 3/044; C11D 11/0041; C11D 3/33; C11D 1/22; C11D 3/2079

(57) ABSTRACT

The present disclosure provides methods and compositions for cleaning soils from surfaces of processing equipment. The soils include aqueous based emulsion polymers that need to be removed from associated polymerization processing equipment. The equipment may be used in the production of paint or coating components. A cleaning composition is heated and applied to the equipment to be cleaned. Cleaning of interior surfaces can be performed using clean-in-place methods. The cleaning composition can include combinations of organic solvent, alkanolamine, water, chelating agent, alkali metal hydroxide, or surfactant.

### CROSS REFERENCE TO RELATED APPLICATIONS

This application claims the benefit of Provisional Application No. 62/657,192 filed on Apr. 13, 2018, which application is incorporated herein by reference.

### TECHNICAL FIELD

The present disclosure relates generally to cleaning compositions and methods for removing polymerized residue. More particularly, the present disclosure relates to the use of cleaning compositions to remove polymerized residue from equipment used in the manufacture of paints and coatings.

### BACKGROUND

The manufacture of paint and coating products involves a variety of specialized equipment and ingredients. The equipment used to process paint and its component ingredients typically involves multiple vessels connected by lines, so that liquids travel through the lines to each vessel in a closed system. The ingredients used in the production of paints and coatings are often polymeric emulsions, which can leave behind polymerized residues that are difficult to remove from the surfaces of the processing equipment.

Polymerized residue buildup within paint processing equipment needs to be removed to help the equipment run properly. If too much residue builds up within the paint processing equipment, lines can become clogged and output can be reduced.

Equipment involved in the production of paint, coatings and associated components includes heat exchangers, transfer lines, reactors, baffles, sweeps, impellers, eductors, holding tanks, valves, and manifolds.

The component ingredients to produce paint and coatings can include aqueous based emulsion polymers such as acrylic, latex, or styrene polymers.

Existing methods of removing polymerized residues from paint and coating processing equipment generally utilize caustic solutions of at least 20% sodium hydroxide (lye). The caustic solutions are used to fill the equipment and are generally heated to boiling. The caustic solution is agitated or circulated within the equipment for as long as 24 hours in order to remove the polymerized residues from interior surfaces of the equipment.

The caustic solutions, especially when heated, pose concerns for safety. Sodium hydroxide is corrosive to skin. In addition, hydroblasting is often required to remove remaining product soils from the paint and coating processing equipment that are either left behind after applying the caustic solution or are not cleaned at all until full or partial blockage prevents cost effective production. Hydroblasting generally involves the use of highly pressurized streams of water (10,000 psi or greater) to remove soils. Hydroblasting has to be done manually and typically involves some degree of equipment disassembly, taking additional time to clean the paint and coating processing equipment. Additionally, hydroblasting can cause injury if done incorrectly. Overall, the existing methods of cleaning paint processing equipment require the equipment to be offline for up to 72 hours.

It is against this background that the present disclosure is made. Techniques and improvements are provided herein.

### SUMMARY

In summary, the present disclosure relates to methods and compositions for cleaning polymerized residues. The residues are formed in the process of manufacturing paints and coatings. In particular, residues that form on the interior surfaces of paint processing equipment can be difficult to remove. The present disclosure presents a method of providing a concentrate cleaning solution that is diluted on site and used to remove polymerized residues from paint processing equipment. The present method is effective for removing residues from equipment using cleaning solutions containing less than 20 wt-% sodium hydroxide at temperatures below boiling that effectively clean the equipment without the aid of hydroblasting in a time period of less than 24 hours. In some embodiments, the concentrate cleaning solution includes a solvent and in other embodiments, a solvent is not required. Various aspects are described in this disclosure, which include, but are not limited to, the following aspects.

In one aspect, a method of cleaning interior residue from paint ingredient production equipment is provided that includes cleaning the interior of the paint ingredient production equipment with a cleaning composition. The cleaning composition includes an organic solvent selected from aromatic alcohol, glycol ether, and mixtures thereof. The cleaning composition further includes alkanolamine and water. In some embodiments, the cleaning composition further includes an alkalinity source. In some embodiments, the cleaning composition further includes surfactant. In some aspects, the cleaning composition has a pH of at least 8 or at least 10. In some embodiments, the cleaning composition is used in a clean-in-place technique. In some aspects, the cleaning composition includes at least 2 wt-% organic solvent, no more than 99 wt-% water, and at least 0.5 wt-% alkanolamine component. In some aspects, the cleaning composition is heated to a temperature of at least 40° C. or at least 55° C.

In another aspect, a method of cleaning residue from interior surface of paint production equipment involves diluting a concentrate composition with water to produce a cleaning composition. The cleaning composition includes at least 2 wt-% organic solvent selected from the group consisting of aromatic alcohol, glycol ether, and mixtures thereof. The cleaning composition further includes at least 0.5 wt-% alkanolamine component, alkalinity source, surfactant component, and no more than 99 wt-% water. The cleaning composition has a pH of 10 or higher. The cleaning composition is heated to a temperature of at least 55° C. and is used to clean the interior surfaces of the paint production equipment in a clean-in-place process. In some embodiments, the cleaning composition further includes fatty acid. In some aspects, the organic solvent is benzyl alcohol. The cleaning composition may include at least 4 wt-% or at least 6 wt-% organic solvent. The cleaning composition may include no more than 50 wt-%, no more than 30 wt-%, or no more than 10 wt-% organic solvent. In some embodiment, the cleaning composition includes 2 wt-% to 10 wt-% organic solvent. The alkanolamine component may be selected from the group consisting of monoethanolamine, diethanolamine, and mixtures thereof. In some aspects, the cleaning composition includes up to 10 wt-%, up to 5 wt-%, at least 1 wt-%, or 0.8 wt-% to 8 wt-% alkanolamine component. In some embodiments, the cleaning composition includes at least 20 wt-% water.

In yet another aspect, a paint production equipment cleaning composition includes 40 to 80 wt-% benzyl alcohol, 12 to 40 wt-% alkanolamine, 1.5 to 10 wt-% alkali metal hydroxide, 3 to 16 wt-% anionic surfactant, 2 to 7 wt-% fatty acid, and water. The pH of the cleaning composition is at least 13. In some embodiments, the anionic surfactant includes sodium dodecylbenzenesulfonic acid. In some aspects, the alkanolamine comprises monoethanolamine. In some embodiments, the alkali metal hydroxide includes sodium hydroxide. In some embodiments, the fatty acid includes oleic acid.

In another aspect, a method of cleaning residue from interior surfaces of paint production is provided that includes diluting a concentrate composition with water to produce a cleaning composition. The concentrate composition includes at least 30 wt-% organic solvent selected from aromatic alcohol, glycol ether, and mixtures thereof. The concentrate composition further includes at least 8 wt-% alkanolamine component. The concentrate composition also includes alkalinity source, surfactant component, and no more than 50 wt-% water. The cleaning composition has a pH of 10 or higher. The cleaning composition is heated to a temperature of at least 55° C. and is applied to the interior surfaces of the paint production equipment in a clean-in-place process.

In some aspects, a method of cleaning residue from interior surfaces of paint production is provided that includes diluting a concentrate composition with water to produce a cleaning composition. The concentrate composition includes an alkalinity source, surfactant component, a chelating agent, and no more than 60 wt-% water. A solvent is not required for this formulation. The cleaning composition has a pH of 10 or higher. The cleaning composition is heated to a temperature of at least 55° C. and is applied to the interior surfaces of the paint production equipment in a clean-in-place process.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is an example schematic of a polymerization processing system;

FIG. 2 shows an example of a testing apparatus set up to evaluate cleaning performance;

FIG. 3A shows a bar graph comparing efficacy of cleaning compositions for removing polymerized residues from stainless steel after 1 hour;

FIG. 3B shows a bar graph comparing efficacy of cleaning compositions for removing polymerized residues from stainless steel after 2 hours;

FIG. 4A shows a bar graph comparing efficacy of various dilutions of a cleaning composition for removing polymerized residues from stainless steel after 30 minutes;

FIG. 4B shows a bar graph comparing efficacy of various dilutions of a cleaning composition for removing polymerized residues from stainless steel after 1 hour;

FIG. 4C shows a bar graph comparing efficacy of various dilutions of a cleaning composition for removing polymerized residues from stainless steel after 2 hours;

FIG. 5A shows a bar graph comparing efficacy of various dilutions of a cleaning composition for removing polymerized residues from stainless steel after 30 minutes;

FIG. 5B shows a bar graph comparing efficacy of various dilutions of a cleaning composition for removing polymerized residues from stainless steel after 1 hour;

FIG. 5C shows a bar graph comparing efficacy of various dilutions of a cleaning composition for removing polymerized residues from stainless steel after 2 hours;

FIG. 6A shows a bar graph comparing efficacy of cleaning compositions for removing polymerized residues from stainless steel after 1 hour;

FIG. 6B shows a bar graph comparing efficacy of cleaning compositions for removing polymerized residues from stainless steel after 3 hours;

FIG. 6C shows a bar graph comparing efficacy of cleaning compositions for removing polymerized residues from stainless steel after 6 hours;

FIG. 7 shows a line graph comparing an experimental cleaning composition with a comparative cleaning composition over the course of 4 hours.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

### Overview

The present disclosure relates to methods of cleaning residues from equipment surfaces using concentrate cleaners that are diluted before use. The methods and cleaning compositions are particularly developed for cleaning processing equipment that is utilized in the manufacture of aqueous based emulsion polymers such as polyacrylates, polystyrene, polyurethane, and latex components and additives used to produce paints and coatings. Paint and coating processing equipment can be difficult to clean because the ingredients form polymerized residues that coat the interior surfaces of the equipment. Paint processing equipment to be cleaned using the present methods can include heat exchangers, fluid lines, baffles, sweeps, polymerization reactors, impellers, eductors, holding tanks, valves, and manifolds.

According to the present disclosure, a concentrate composition is provided including at least organic solvent, alkanolamine, and water that can be stored in stable condition. Before applying to the equipment, the composition is diluted with water from a local source. This reduces shipping costs of the cleaning composition and no additional treatment of the water is required. In some instances, the diluted cleaning solution is heated before application to the equipment. The diluted, heated composition is applied to the equipment until the residue is removed—usually for about 30 minutes to 4 hours.

The methods and compositions provide the benefit of providing more effective cleaning of interior surfaces of polymerization processing equipment over prior techniques. Equipment can be cleaned in less time, reducing the amount of time that equipment is offline. The time required to effectively clean the interior surfaces of polymerization equipment using a clean-in-place technique is less than 12 hours. In some embodiments, the equipment can be cleaned in less than 6 hours.

Methods according to the present disclosure allow for cleaning using cleaning compositions including less than 20 wt-% sodium hydroxide. The cleaning compositions can include less than 10 wt-% sodium hydroxide.

The cleaning compositions are heated to less than 100° C. before applying to equipment surfaces. In some instances, the cleaning compositions are heated to no more than 90° C.

Agitation can be applied to aid in cleaning, but pressures applied to cleaning solutions do not exceed 10,000 psi. In some instances, the solution is not agitated or pressurized to greater than 5,000 psi.

### Example Processing Equipment System

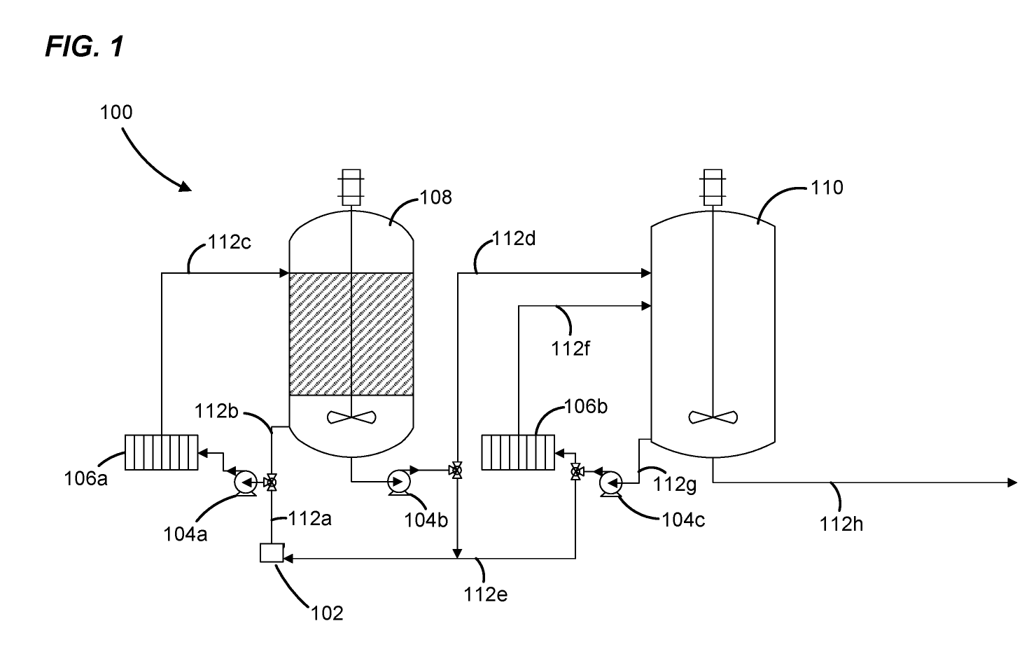

FIG. 1 is a schematic of an example emulsion polymerization system 100 used to produce paints and coatings. The equipment depicted includes a system of heat exchangers 106, a reactor 108, and a blend tank 110 connected by lines 112. Pumps 104 are used to move liquids through the lines 112. This system 110 is merely an example of a system that could be cleaned using the present compositions and methods.

Polymer emulsions and their components are circulated through the lines 112 and are processed in the reactor 108 and blend tank 110. All parts of the system 110 can become coated or clogged with polymerized residues that, if not cleaned regularly, can cause problems with the paint production process. In order to clean the interior surfaces of all of these parts of the system 110, production of paint and coatings must be halted so that cleaning solution can be introduced into the system 110.

The cleaning solution is diluted with water on side and is introduced to the system from a cleaning solution delivery system, such as a CIP. 102. The diluted cleaning solution is then pumped through line 112a which leads to pump 104a. The solution moves from pump 104a to heat exchanger 106a where heat is applied to the liquid. The solution then travels through line 112c to the reactor 108 where it is agitated. The liquid can make another pass through the reactor by traveling through line 112b. Pump 104b then moves the liquid from the reactor 108 to line 112d which is a transfer line. Alternatively, the liquid can travel through line 112e back to the source of the cleaning solution 102. Liquid that travels through the transfer line 112d ends up in the blend tank 110. Solution from the blend tank 110 can travel through line 112g to pump 104c to be circulated to the heat exchanger 106b or back to the cleaning solution source 102 through line 112e. Liquid that is heated at the heat exchanger 106b returns to the blend tank through line 112f. Finally, the contents of the blend tank pass through line 112h to be recycled or disposed.

Heat and agitation can be applied at one or more points in the system 110 to facilitate cleaning. Agitation can be supplied not only from the pumps, but also from stirring solution within the reactor 108 or blend tank 110. In some instances, cleaning solution could be sprayed on surfaces within the system 100 to provide agitation, but at pressures of less than 10,000 psi, preferably less than 5,000 psi.

### Compositions

The compositions of the present disclosure are utilized to aid in the removal of polymerized materials used to produce paint and coating products. Preferably, the cleaning compositions are provided in concentrate form. The concentrate is generally storage stable. The concentrate may be diluted before use with a suitable solvent such as water. Any suitable water source at the site of dilution may be utilized. For example, the concentrate compositions may be diluted with water at a 1:4 ratio to form a 20% solution, at a 1:9 ratio to form a 10% solution, or at a 1:19 ratio to form a 5% solution. Depending on the application, a diluted solution having 10-20% by volume of the concentrate cleaning composition may provide the most effective cleaning.

### Organic Solvent

Compositions of the present disclosure may include organic solvents. In some embodiments, the organic solvents are selected from aromatic alcohols and glycolic ethers. Aromatic alcohols can include benzyl alcohol, tryptophol, tyrosol, and phenethyl alcohol. Glycol ethers can include ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, propylene glycol methyl ether, diethylene glycol monomethyl ether, diethylene glycol mono-n-butyl ether, 2-butoxyethanol, diethylene glycol monoethyl ether, and dipropyleneglycol methyl ether.

In some embodiments, a concentrate cleaning composition comprises at least 30 wt-%, at least 35 wt-%, at least 40 wt-%, at least 45 wt-%, at least 50 wt-%, at least 55 wt-%, or at least 60 wt-% organic solvent. In some embodiments, a concentrate cleaning composition comprises no more than 90 wt-%, no more than 80 wt-%, or no more than 70 wt-% organic solvent. Concentrate cleaning compositions according to the present disclosure can include from 30 wt-% to 90 wt-%, from 40 wt-% to 80 wt-%, or from 50 wt-% to 70 wt-% organic solvent. In some embodiments a concentrate cleaning composition comprises from 30 wt-% to 50 wt-%, 40 wt-% to 60 wt-%, 50 wt-% to 70 wt-%, or 60 wt-% to 80 wt-% organic solvent.

In some embodiments, a diluted use solution comprises at least 2 wt-%, at least 4 wt-%, at least 6 wt-%, at least 8 wt-%, or at least 10 wt-% organic solvent. Diluted use solutions of the present disclosure can include no more than 50 wt-% organic solvent, no more than 40 wt-% organic solvent, no more than 30 wt-% organic solvent, no more than 20 wt-% organic solvent, or no more than 10 wt-% organic solvent. In some embodiments, a use solution of the cleaning composition comprises from 2 wt-% to 50 wt-%, from 4 wt-% to 40 wt-%, from 6 wt-% to 30 wt-%, or from 8 wt-% to 20 wt-% organic solvent. In some embodiments, a use solution comprises from 2 wt-% to 10 wt-%, from 4 wt-% to 12 wt-%, from 6 wt-% to 14 wt-%, or from 8 wt-% to 16 wt-% organic solvent.

In some embodiments, the concentrate and diluted use solutions are free of organic solvent.

### Alkanolamine

Cleaning compositions of the present disclosure may also include alkanolamine component. In some embodiments, the alkanolamine component is selected from the group consisting of monoethanolamine (MEA), diethanolamine (DEA) and mixtures thereof.

In some embodiments, concentrate cleaning compositions of the present disclosure comprise at least 8 wt-%, at least 12 wt-%, at least 16 wt-%, at least 20 wt-%, at least 24 wt-%, or at least 28 wt-% alkanolamine component. In some embodiments, the concentrate cleaning composition comprises up to 50 wt-%, up to 45 wt-%, up to 40 wt-%, up to 35 wt-%, up to 30 wt-%, or up to 25 wt-% alkanolamine. Concentrate cleaning compositions according to the present disclosure can include from 8 wt-% to 50 wt-%, from 12 wt-% to 40 wt-%, or from 16 wt-% to 30 wt-% alkanolamine. In some embodiments, concentrate cleaning compositions comprise from 8 wt-% to 16 wt-%, from 10 wt-% to 18 wt-%, from 12 wt-% to 20 wt-%, from 14 wt-% to 22 wt-%, from 16 wt-% to 24 wt-%, or from 18 wt-% to 26 wt-% alkanolamine component.

In some embodiments, dilute use solutions of the cleaning composition comprise at least 0.5 wt-%, at least 1 wt-%, at least 1.5 wt-%, at least 2 wt-%, at least 2.5 wt-%, at least 3 wt-%, at least 3.5 wt-%, at least 4 wt-%, at least 4.5 wt-% or at least 5 wt-% alkanolamine component. In some embodiments, use solutions comprise no more than 10 wt-%, no more than 8 wt-%, no more than 7 wt-%, no more than 6 wt-%, no more than 5 wt-%, no more than 4.5 wt-%, or no more than 4 wt-% alkanolamine component. In some embodiments, the use solutions of the present disclosure comprise from 0.8 wt-% to 8 wt-%, 1.2 wt-% to 6 wt-%, from 1.6 wt-% to 4 wt-%, or 1.9 to 3.8 wt-% alkanolamine component. Use solutions of the cleaning composition can comprise from 1 wt-% to 2 wt-%, from 1.5 wt-% to 2.5 wt-%, from 2 wt-% to 3 wt-%, from 2.5 wt-% to 3.5 wt-%, from 3 wt-% to 4 wt-%, from 3.5 wt-% to 4.5 wt-%, or from 4 wt-% to 5 wt-% alkanolamine component.

In some embodiments, the concentrate and diluted use solutions are free of alkanolamines.

### Surfactant

In some embodiments, the cleaning composition includes one or more surfactants. In some embodiments, the surfactant is an anionic surfactant. Suitable anionic surfactants for use in the present compositions include one or more of sulfates, sulfonates, phosphates, and carboxylates. In some embodiments, the anionic surfactant is selected from the group consisting of benzenesulfonates, naphthalenesulfonates, and sulfonate esters. In some embodiments, the anionic surfactant is a benzenesulfonate selected from the group consisting of benzenesulfonic acid, sodium dodecylbenzenesulfonate, and sodium nonanoyloxybenzenesulfonate. Other surfactants that can be used in the composition include sodium xylene sulfonate. In some embodiments, the surfactant is a nonionic surfactant. Suitable nonionic surfactants include alcohol ethoxylates, ethoxylate/propoxylate copolymers, and alkyl glucosides.

In some embodiments, a concentrate cleaning composition comprises at least 0.5 wt-%, at least 2 wt-%, at least 3 wt-%, at least 4 wt-%, or at least 5 wt-% surfactant. Concentrate cleaning compositions according to the present disclosure can include up to 20 wt-%, up to 17 wt-%, up to 14 wt-%, up to 11 wt-%, or up to 8 wt-% surfactant. In some embodiments, concentrate cleaning composition comprise from 0.5 wt-% to 20 wt-%, from 3 wt-% to 16 wt-%, from 4 wt-% to 12 wt-%, or from 5 wt-% to 8 wt-% surfactant. In some embodiments, concentrate cleaning compositions comprise from 1 wt-% to 4 wt-%, from 2 wt-% to 5 wt-%, from 3 wt-% to 6 wt-%, from 4 wt-% to 7 wt-%, from 5 wt-% to 8 wt-%, or from 6 wt-% to 9 wt-% surfactant.

Use solutions of cleaning compositions according to the present disclosure can include at least 0.25 wt-%, at least 0.5 wt-%, at least 0.75 wt-%, or at least 1 wt-% surfactant. Use solutions comprise up to 2.5 wt-%, up to 2 wt-%, up to 1.5 wt-%, or up to 1 wt-% surfactant. In some embodiments, use solutions of the cleaning composition comprise from 0.25 wt-% to 2.5 wt-%, from 0.5 wt-% to 2 wt-%, or from 0.75 wt-% to 1.5 wt-% surfactant. In some embodiments, use solutions comprise from 0.25 wt-% to 0.75 wt-%, from 0.5 wt-% to 1 wt-%, from 0.75 wt-% to 1.25 wt-%, or from 1 wt-% to 1.5 wt-% surfactant.

In some embodiments, the cleaning composition is substantially free of fluorosurfactants. In some embodiments, the cleaning composition comprises less than 0.1 wt-%, less than 0.01 wt-%, less than 0.001 wt-%, or less than 0.0001 wt-% fluorosurfactants.

### Alkalinity Source

In some embodiments, cleaning compositions of the present disclosure include alkalinity source. The alkalinity source can include hydroxide. In some embodiments, the hydroxide is an alkali metal hydroxide. Alkali metal hydroxides used in the present composition can include sodium hydroxide, potassium hydroxide, rubidium hydroxide, caesium hydroxide, and lithium hydroxide. In some embodiments, the cleaning compositions comprise an alkalinity source selected from sodium hydroxide, potassium hydroxide, and mixtures thereof.

In some embodiments, concentrate cleaning compositions of the present disclosure comprise at least 1 wt-%, at least 1.5 wt-%, at least 2 wt-%, or at least 2.5 wt-% alkalinity source. Concentrate cleaning compositions can include up to 40 wt-%, up to 30 wt-%, up to 20 wt-%, up to 15 wt-%, up to 12 wt-%, up to 10 wt-%, up to 9 wt-%, or up to 6 wt-% alkalinity source. In some embodiments, concentrate cleaning compositions comprise from 1 wt-% to 40 wt-%, from 1.5 wt-% to 30 wt-%, from 2 wt-% to 20 wt-%, from 2 wt-% to 6 wt-%, or from 2.5 wt-% to 3 wt-% alkalinity source. In some embodiments, the concentrate cleaning composition comprises from 1 wt-% to 3 wt-%, from 2 wt-% to 4 wt-%, from 3 wt-% to 5 wt-%, from 4 wt-% to 6 wt-%, or from 5 wt-% to 7 wt-% alkalinity source.

Use solutions according to the present disclosure comprise at least 0.05 wt-%, at least 0.1 wt-%, at least 0.2 wt-%, at least 0.25 wt-%, at least 0.3 wt-%, or at least 0.5 wt-% alkalinity source. In some embodiments, the use solution comprises no more than 10 wt-%, no more than 5 wt-%, no more than 4 wt-%, no more than 3 wt-%, or no more than 2 wt-% alkalinity source. In some embodiments, use solutions comprise from 0.05 wt-% to 5 wt-%, from 0.1 wt-% to 4 wt-%, from 0.2 wt-% to 3 wt-%, from 0.3 wt-% to 2 wt-%, or from 0.5 wt-% to 1 wt-% alkalinity source. Use compositions of the cleaning composition according to the present disclosure can include from 0.05 wt-% to 0.5 wt-%, from 0.1 wt-% to 1 wt-%, from 0.25 wt-% to 2 wt-%, or from 0.3 wt-% to 1 wt-%.

In some embodiments, compositions according to the present disclosure include 20 wt-% or less sodium hydroxide.

### Fatty Acid

In some embodiments, cleaning compositions of the present disclosure may include a fatty acid component. Suitable fatty acids can be selected from the group consisting of oleic acid, linoleic acid, lauric acid, octanoic acid, stearic acid, palmitic acid, capric acid, palmitoleic acid, and mixtures thereof. In some embodiments, the cleaning composition includes a fatty acid comprising oleic acid.

In some embodiments, concentrate cleaning compositions comprise at least 0.5 wt-%, at least 1 wt-%, at least 1.5 wt-%, or at least 2 wt-% fatty acid. Concentrate cleaning compositions according to the present disclosure can include up to 10 wt-%, up to 9 wt-%, up to 8 wt-%, up to 7 wt-%, or up to 6 wt-% fatty acid. In some embodiments, concentrate cleaning compositions comprise from 0.5 wt-% to 10 wt-%, from 1 wt-% to 9 wt-%, from 1.5 wt-% to 8 wt-%, from 2 wt-% to 7 wt-%, from 2.5 wt-% to 6 wt-%, or from 3 wt-% to 5 wt-% fatty acid. In some embodiments, concentrate cleaning compositions comprise from 0.5 wt-% to 2.5 wt-%, from 1 wt-% to 3 wt-%, from 1.5 wt-% to 3.5 wt-%, from 2 wt-% to 4 wt-%, from 3 wt-% to 5 wt-%, or from 4 wt-% to 6 wt-% fatty acid.

In some embodiments, use solutions of the present disclosure comprise at least 0.05 wt-%, at least 0.1 wt-%, at least 0.15 wt-%, or least 0.2 wt-% fatty acid. In some embodiments, use solutions of the cleaning composition comprise no more than 3 wt-%, no more than 2 wt-%, or no more than 1 wt-% fatty acid. In some embodiments, use solutions of the cleaning composition comprise from 0.05 wt-% to 0.3 wt-%, from 0.1 wt-% to 0.35 wt-%, from 0.15 wt-% to 0.4 wt-%, from 0.2 wt-% to 0.45 wt-%, from 0.25 wt-% to 0.5 wt-%, from 0.3 wt-% to 0.55 wt-%, from 0.35 wt-% to 0.6 wt-%, from 0.4 wt-% to 0.65 wt-%, or from 0.45 wt-% to 0.7 wt-%.

### Chelating Agent

In some embodiments, the concentrate cleaning compositions of the present disclosure may include a chelating agent. Suitable chelating agents include an aminocarboxylic acid, a condensed phosphate, a phosphonate, a polyacrylate, and the like. In general, a chelating agent is a molecule capable of coordinating (i.e., binding) the metal ions commonly found in natural water to prevent the metal ions from interfering with the action of the other detersive ingredients of a cleaning composition. An iminodisuccinate (available commercially from Bayer as IDS™) or sodium glucoheptanoate may be used as a chelating agent. Exemplary aminocarboxylic acids include, for example, N-hydroxyethyliminodiacetic acid, nitrilotriacetic acid (NTA), ethylenediaminetetraacetic acid (EDTA), N-hydroxyethyl-ethylenediaminetriacetic acid (HEDTA), diethylenetriaminepentaacetic acid (DTPA), methylglycinediacetic acid (MGDA), glutamic acid diacetic acid (GLDA), and the like. Exemplary condensed phosphates include sodium and potassium orthophosphate, sodium and potassium pyrophosphate, sodium tripolyphosphate, sodium hexametaphosphate, and the like. The composition may include a phosphonate such as 1-hydroxyethane-1,1-diphosphonic acid, 2-phosphonobutane-1,2,4 tricarboxylic acid, and the like. Polymeric polycarboxylates may also be included in the composition. Those suitable for use as cleaning agents have pendant carboxylate groups and include, for example, polyacrylic acid, maleic/olefin copolymer, acrylic/maleic copolymer, polymethacrylic acid, acrylic acid-methacrylic acid copolymers, and the like.

In some embodiments, concentrate cleaning compositions comprise at least 0.1 wt-%, at least 0.5 wt-%, at least 1 wt-%, or at least 2 wt-% chelating agent. Concentrate cleaning compositions according to the present disclosure can include up to 20 wt-%, up to 15 wt-%, or up to 10 wt-% chelating agent.

In some embodiments, use solutions of the present disclosure comprise at least 0.01 wt-%, at least 0.05 wt-%, or at least 0.1 wt-% chelating agent. In some embodiments, use solutions of the cleaning composition comprise no more than 5 wt-%, no more than 3 wt-%, or no more than 1 wt-% chelating agent.

### Water

In some embodiments, concentrate cleaning compositions of the present disclosure include water. Use compositions of the present disclosure are diluted with water before use. The water can be sourced at the point where the composition will be diluted. No particular water conditions are required. In some embodiments, use solutions of the cleaning composition comprise at least 20 wt-% or at least 50 wt-% water. In some embodiments, use solutions comprise no more than 95 wt-%, no more than 97 wt-%, no more than 99 wt-%, and no more than 99.9 wt-% water. Concentrate cleaning compositions of the present disclosure comprise no more than 5 wt-%, no more than 10 wt-%, no more than 15 wt-%, no more than 20 wt-%, no more than 30 wt-%, or no more than 50 wt-% water. In some embodiments, use solutions include from 80 to 95 wt-% water.

In some embodiments, cleaning compositions of the present disclosure further include one or more additional ingredients. Additional ingredients may include thickeners, hydrotropes, corrosion inhibitors, and buffering agents. In some embodiments, concentrate cleaning compositions comprise up to 5 wt-%, up to 4 wt-%, up to 3 wt-%, up to 2 wt-%, or up to 1 wt-% additional ingredients. In some embodiments, concentrate cleaning compositions according to the present disclosure include at least 0.1 wt-%, at least 0.3 wt-%, at least 0.5 wt-%, or at least 1 wt-% additional ingredients. Use solutions of the cleaning composition can include up to 0.5 wt-%, up to 0.4 wt-%, up to 0.3 wt-% or up to 0.25 wt-% additional ingredients. In some embodiments, use solutions comprise at least 0.005 wt-%, at least 0.01 wt-%, or at least 0.1 wt-% additional ingredients.

Compositions according to the present disclosure are alkaline and have a pH of at least 8, at least 9, at least 10, at least 11, at least 12, or at least 13. In some embodiments, the cleaning compositions have a pH of from 8-14, from 9-14, from 10-14, from 11-14, from 12-14, from 13-14, or from 13.5-14.

Concentrate compositions according to the present disclosure are generally stable in storage. For best results, concentrate compositions are diluted with water for use shortly before applying to the machinery to be cleaned.

### Example Cleaning Compositions

TABLE A
Concentrate Cleaning Compositions (wt-%) (with solvent)

| | | | |
|---|---|---|---|
| Organic solvent | 30-90 | 40-80 | 50-70 |
| Alkanolamine | 8-50 | 12-40 | 16-30 |
| Surfactant | 2-20 | 3-16 | 4-12 |
| Alkalinity source | 1-15 | 1.5-10 | 2-6 |
| Fatty acid | 0.5-10 | 1-9 | 1.5-8 |
| Water | Balance | Balance | Balance |

TABLE B
Diluted Use Cleaning Compositions (wt-%) (with solvent)

| | | | |
|---|---|---|---|
| Organic solvent | 2-50 | 4-40 | 6-30 |
| Alkanolamine | 0.8-8 | 1.2-6 | 1.6-4 |
| Surfactant | 0.25-2.5 | 0.5-2 | 0.75-1.5 |
| Alkalinity source | 0.05-5 | 0.1-4 | 0.2-3 |
| Fatty acid | 0.05-0.3 | 0.1-0.35 | 0.15-0.4 |
| Water | Balance | Balance | Balance |

TABLE C
Concentrate Cleaning Compositions (wt-%) (without solvent)

| | | | |
|---|---|---|---|
| Chelating agent | 0.1-20 | 0.5-15 | 1-10 |
| Surfactant | 0.1-20 | 0.5-16 | 1-12 |
| Alkalinity source | 1-40 | 1.5-30 | 2-20 |
| Water | Balance | Balance | Balance |

TABLE D
Diluted Use Cleaning Compositions (wt-%) (without solvent)

| | | | |
|---|---|---|---|
| Chelating agent | 0.01-5 | 0.05-3 | 0.05-1 |
| Surfactant | 0.01-2.5 | 0.05-2 | 0.75-1.5 |
| Alkalinity source | 0.05-10 | 0.1-5 | 0.2-3 |
| Water | Balance | Balance | Balance |

### Cleaning Method & Conditions

Equipment used in the manufacture of paint and coatings involves many pipes, vessels and other equipment. As discussed above, the surfaces of such equipment must be regularly cleaned to maintain efficacy of the manufacturing equipment. In order to properly clean the interior surfaces of such equipment without disassembling the equipment, clean-in-place (CIP) methods of cleaning are most suitable. CIP techniques are faster, less labor intensive, and safer for employees. In some cases, clean in place methods can be automated using programmable logic controllers, sensors, heat exchangers and other data acquisition machines. In general, clean-in-place cleaning methods utilize solutions that are applied to the interior surfaces of the equipment in such a manner to loosen and remove soils and residue. Generally, the solutions are applied and circulated in such a way that a turbulent flow is created such as spraying, circulating, or stirring. In many cases, elevated temperature or chemical ingredients are included in clean in place techniques to improve cleaning efficacy.

In some embodiments, methods of the present disclosure involve heating cleaning compositions either before application to the equipment or during application. For some applications, cleaning compositions are diluted and then heated before introducing the solutions into the equipment. For application to the equipment, a diluted use solution of cleaning composition can be used to fill the insert equipment here and heat is applied to the equipment thus heating the cleaning composition.

The cleaning compositions are heated to a temperature sufficient to remove polymerized residue from the surfaces of the equipment to be cleaned. In some embodiments, cleaning compositions are heated to a temperature of a least 40° C., at least 45° C., at least 50° C., at least 55° C., at least 60° C., at least 65° C., or least 70° C. In some embodiments, the cleaning composition is heated to a temperature of no more than 140° C., no more than 135° C., no more than 130° C., no more than 125° C., no more than 120° C., no more than 110° C., no more than 105° C., or no more than 100° C. In some embodiments, the step of heating the cleaning composition occurs at a temperature of from 40° C.-120° C., from 50° C.-110° C., 60° C.-100° C., 40° C.-100° C., 60° C.-120° C., 70° C.-80° C., 60° C.-90° C., or 40° C.-70° C., inclusive.

Cleaning compositions according to the present disclosure are applied to the paint and coating manufacturing equipment for a period of time effective to clean the equipment. Examples of effective cleaning time periods include at least 15 minutes, at least 30 minutes, at least 45 minutes, at least 1 hour, at least 2 hours, or at least 4 hours. In some embodiments, effective cleaning time periods include less than 12 hours, less than 9 hours, less than 6 hours, less than 4 hours, or less than 2 hours. In some embodiments, the effective time of application of cleaning solution is from 15 minutes to 12 hours, from 30 minutes to 6 hours, from 1 hour to 4 hours, 2 hours to 4 hours, or from 1.5 hours to 3 hours. In some embodiments, the cleaning compositions are applied for 1-2 hours, 2-3 hours, or 3-4 hours. The term “effective cleaning” as used in the present disclosure refers to a reduction in soil on surfaces of equipment to be cleaned.

In some embodiments, solids can be removed from solution and the solution can be reused.

### EXAMPLES

### Experimental Set Up for Cleaning Performance Test

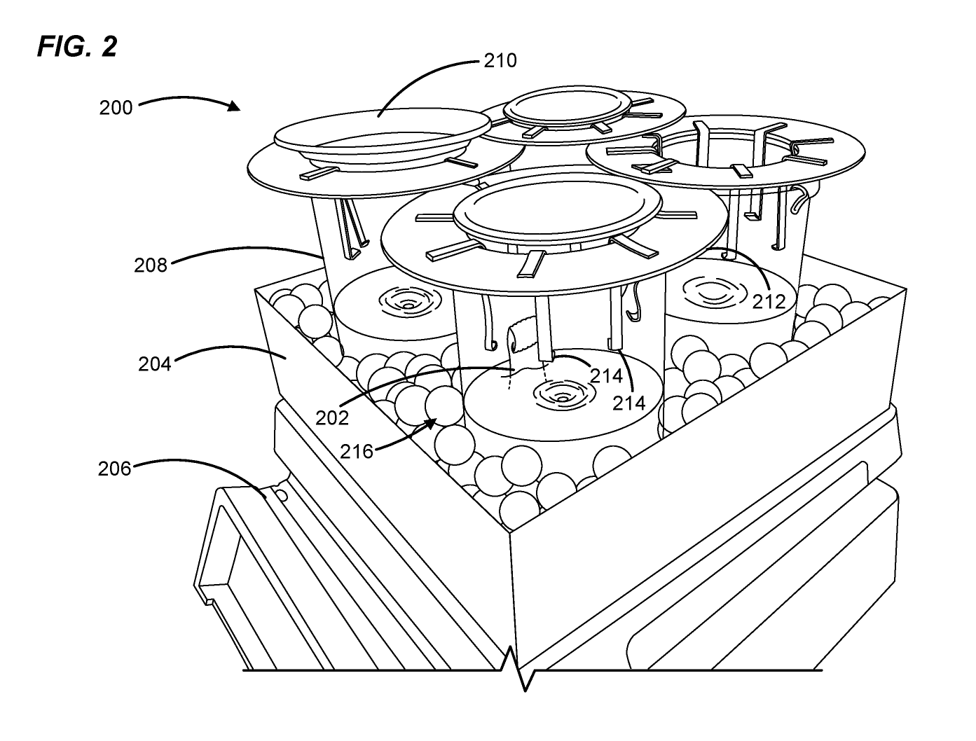

An example set up 200 for testing performance of cleaning compositions for removing polymerized soils from stainless steel is depicted in FIG. 2. Stainless steel coupons 202 were cut and passivated. Soiled steel coupons were prepared by dipping into liquid soil samples and allowing to dry at room temperature for 24 hours. In some instances, multiple layers were applied, including composite soils. A stainless steel pan 204 was constructed to cover a heated stir plate 206. Glass beakers 208 were placed over the steel pan 204, filled with water, and covered with watch glasses 210. Samples of at least 500 mL of each cleaning chemistry to be evaluated were prepared. Stainless steel flat rings 212 were constructed to be laid on the lip of each beaker 208, with small hooks 214 extending down into the beaker 208. The steel pan 204 was placed on the heated stir plate 206. Glass beakers 208 were placed in the pan over mixers of the stir plate 206 and the pan 204 was filled with water. A stir bar was placed in each glass beaker 208, and the glass beakers 208 were filled with the chemistry to be tested. Float bath balls 216 were added to the pan 204 to cover the water. Stainless steel rings 212 were placed over the beakers 208 and watch glasses 210 were placed over each beaker 208. A thermocouple was placed in a beaker 208 and the heated stir plate 206 was set to 70° C. The stir plate 206 was set to mix at a setting sufficient to pull a vortex extending ¼ into the solution inside the beakers 208. Soil removal of the stainless steel coupons 202 was measured visually at regular intervals.

### Experimental Test Materials

The following materials were used in the Examples to test the efficacy of soil removal from stainless steel coupons using various cleaning compositions.

TABLE 1
Sample Soils

| Soil | Material |
|---|---|
| Soil A | Aqueous acrylic emulsion |
| Soil B | Aqueous acrylic emulsion |
| Soil C | Aqueous acrylic emulsion |
| Soil D | Self-crosslinking polyurethane dispersion |
| Soil E | Styrene acrylic emulsion |
| Soil F | Acrylic latex |
| Soil G | Acrylic emulsion |
| Soil H | Combination acrylic emulsion |

TABLE 2
Experimental Cleaning Compositions 1 and 2

| Experimental | Experimental | Comparative | Comparative |
|---|---|---|---|
| Composition | Composition | Composition | Composition |
| #1 | #2 | #1 | #2 |
| (EC#1) | (EC#2) | (CC#1) | (CC#2) |
| 30-60% benzyl | 40-60% Biosoft | 5-10% 1-methoxy- | 85-86% water |
| alcohol | nonionic | 2-propanol | |
| | surfactant | | |
| 10-30% DI | 20-30% | 1-5% sodium | 0.2-0.3% |
| water | Steposol | dodecylbenzene | NaOH |
| | MET-10U | sulfonate | |
| | (surfactant) | | |
| 5-10% sodium | 20-30% MEA | 1-5% NaOH | 2.5-3.0% |
| dodecylbenzene | | | sodium |
| sulfonate (DBSA) | | | metasilicate |
| | | | pentahydrate |
| 10-30% | | 1-5% sodium | 1.8-2.0% |
| monoetha- | | xylenesulfonate | Rhodafac |
| nolamine | | | (surfactant) |
| (MEA) | | | |
| 1-5% NaOH | | 1-5% ethylene- | 1.8-2.0% MEA |
| | | diamine | |
| | | tetraacetate | |
| 1-5% Oleic acid | | | 0.3-0.5% |
| | | | EDTA |
| | | | 7.5-8.0% butyl |
| | | | propasol |

### Example 1

The purpose of this test was to find a cleaning formula that is more effective at cleaning aqueous based emulsion polymer soils from paint manufacturing equipment than existing benchmark compositions. More effective cleaning was defined by amount of soil removed in a given time period, with shorter times being preferred. A cleaning test was performed to evaluate performance of different cleaning compositions on a variety of soil samples. Table 1 describes the soil samples utilized and Table 2 describe the Experimental Cleaning Compositions utilized.

Stainless steel coupons were dipped in each liquid soil, allowed to dry, and cured for 7 days at room temperature. Five coupons were used for each soil. Using the set up described above, each cleaning composition was heated to 70° C. and was agitated with a stir bar. Each of the cleaning compositions was used undiluted.

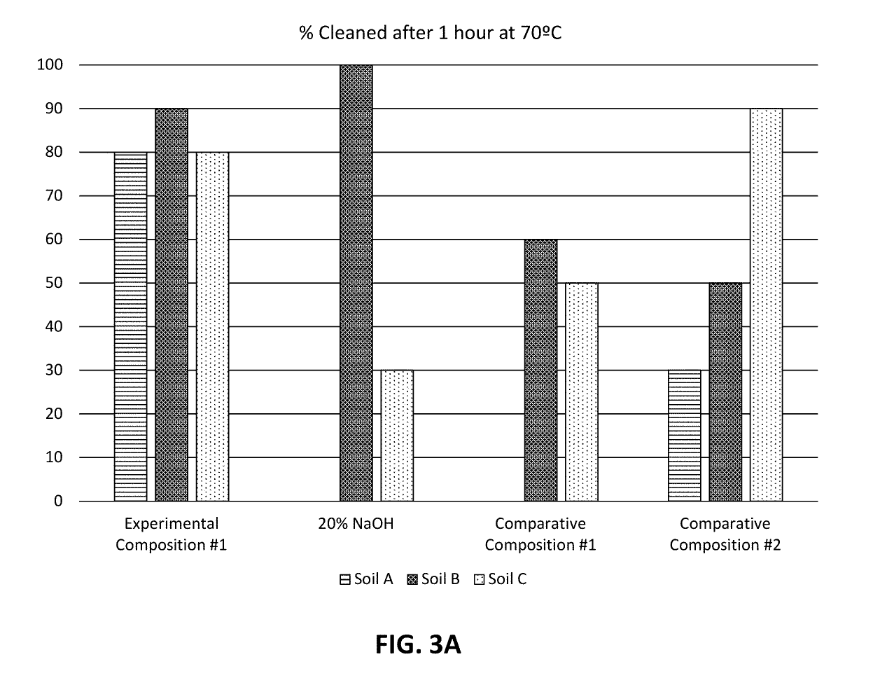

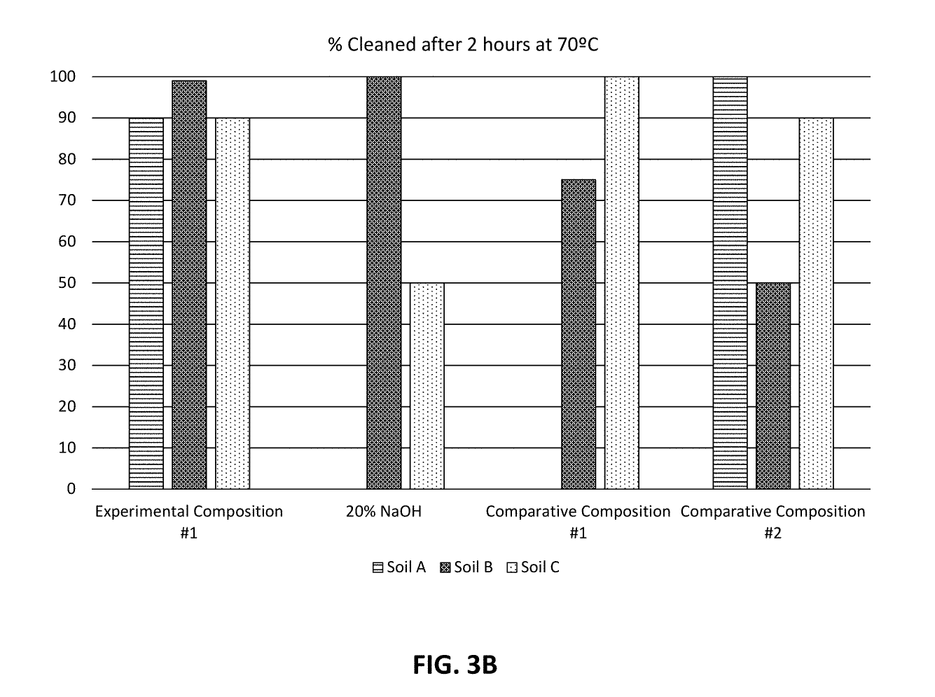

FIGS. 3A-3B show graphs of the results of testing. Soil A was most effectively removed by Experimental Composition #1 (EC#1) with 80% removal after 1 hour and 90% removal after 2 hours. The 20% NaOH composition and Comparative Composition #1 (CC#1) did not remove any soil from coupons soiled with Soil A, even after 2 hours. CC #2 was effective at removing all Soil A after 2 hours, but only removed 30% of Soil A after 1 hour. Both Experimental Composition #1 and 20% NaOH were effective at removing Soil B, removing all soil within 2 hours. Comparative Composition #1 and #2 were somewhat effective in removing Soil B, removing 75% and 50% of the soil respectively. Experimental Composition #1, Comparative Composition #1 and Comparative Composition #2 showed great efficacy in removing Soil C, all removing the majority of soils after only an hour and removing at least 90% of soils after 2 hours. EC #1 was the most effective overall in removing all three soils.

### Example 2

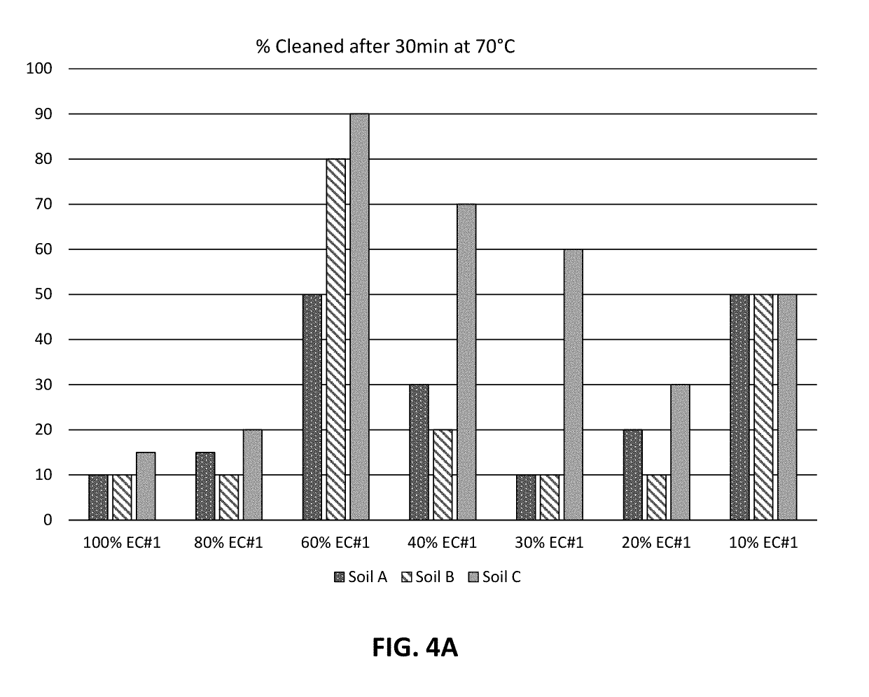

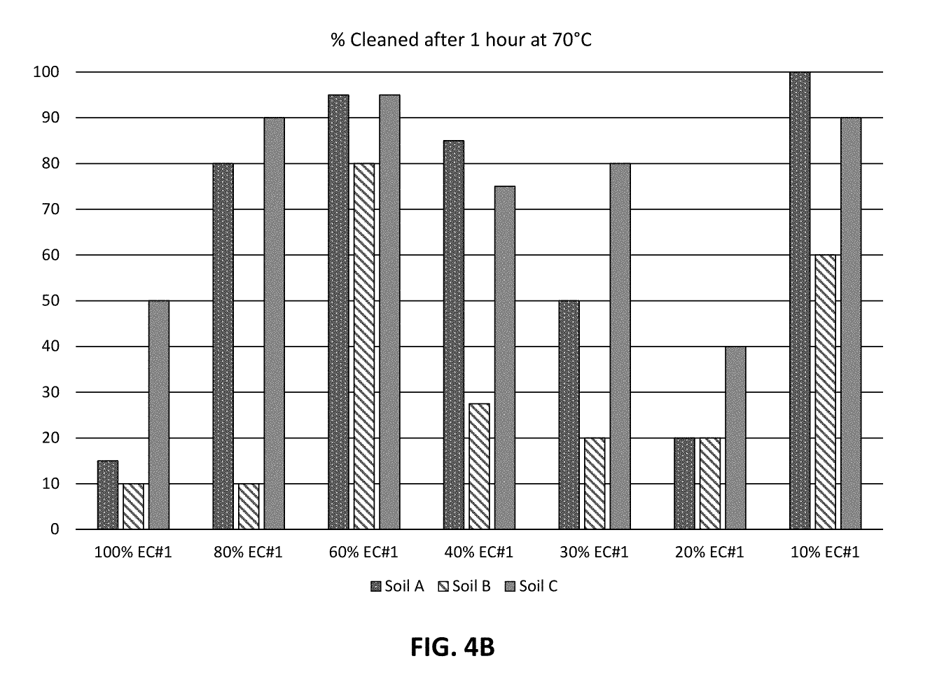

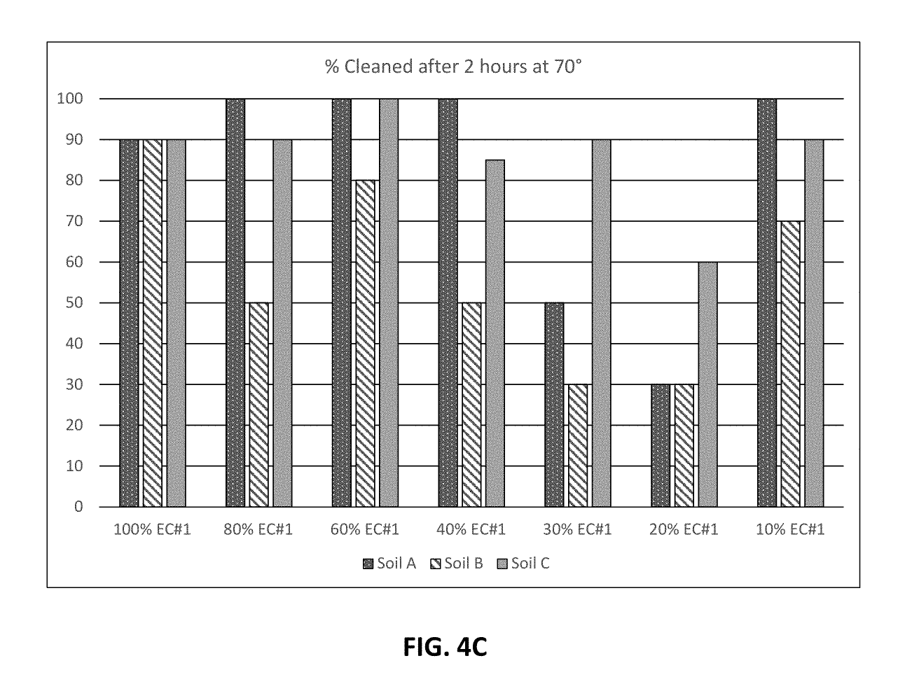

Dilutions of Experimental Composition #1 (EC#1) were examined for their efficacy in removing soils from stainless steel. FIGS. 4A-4C show compositions containing 100%, 80%, 60%, 40%, 30%, 20%, and 10% Experimental Composition #1 with water making up the remainder of the solution. The amount of soil removed (% cleaned) for each of Soil A, Soil B, and Soil C was examined after 30 minutes, 1 hour, and 2 hours.

FIG. 4A displays the results for cleaning at 70° C. after 30 minutes. Soil A was most effectively cleaned with solutions of 60% EC#1 or 10% EC#1, though no more than 50% of the soil was ever removed at the 30 minute mark (FIG. 4A). Soil B was most effectively removed using a 60% EC#1 solution, with 10% EC#1 being the next most effective after 30 minutes. Soil C was also most effectively cleaned with a 60% EC#1 solution, with lessening efficacy moving down to 20% EC#1 but then increasing to 50% soil removed at a 10% EC#1 solution.

FIG. 4B displays the results for cleaning at 70° C. after 1 hour. Removal of Soils A and C was much more effective after treating for an hour compared to 30 minutes while removal of Soil B remained about the same. The same general trend of peak cleaning came at 60% EC#1 and 10% EC#1. Only 10% EC#1 was effective at completely removing Soil A.

After 2 hours, Soil A was completely removed by most EC#1 dilution solutions (FIG. 3C). The 30% and 20% solutions were least effective for removing Soil A. Soil B was best removed with the 100% EC#1 solution, with 90% of soil being cleaned. Good soil removal was also achieved with the 60% and 10% EC#1 solutions. 100% of Soil C was removed with the 60% EC#1 solution. Over 80% of soil was also removed with all but the 20% EC#1 solution.

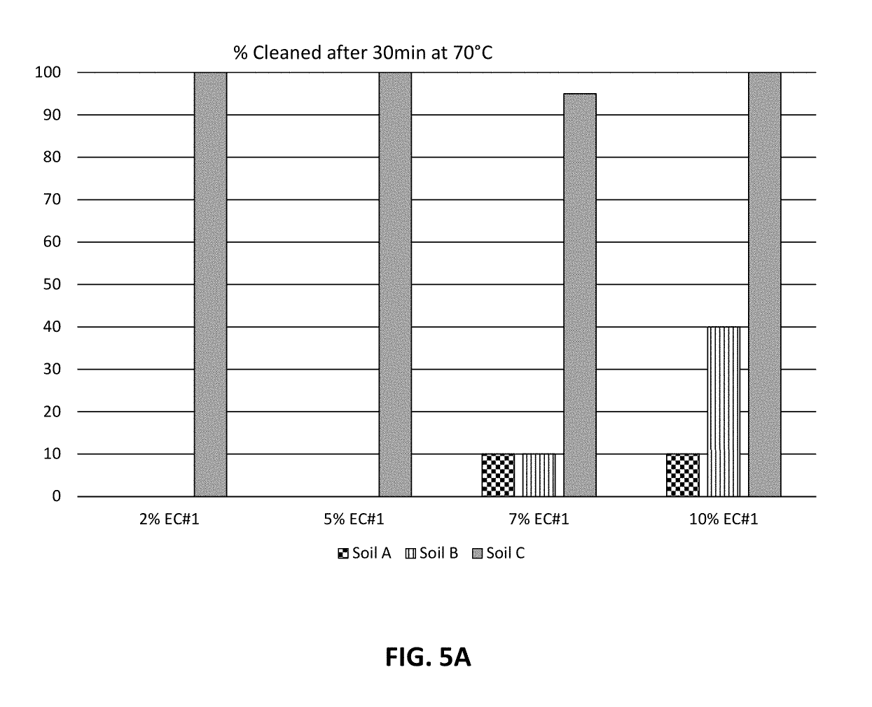

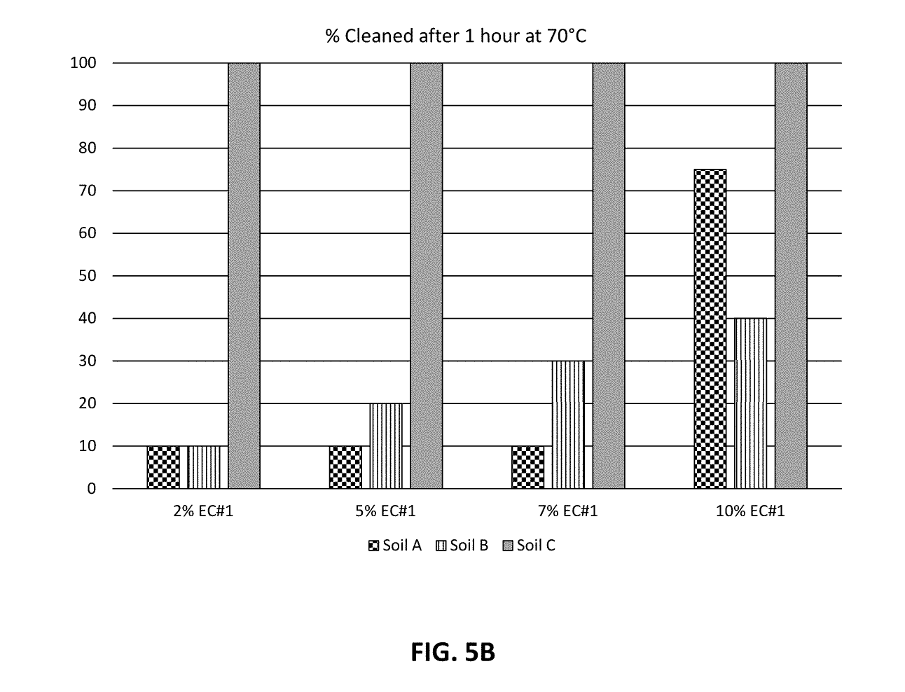

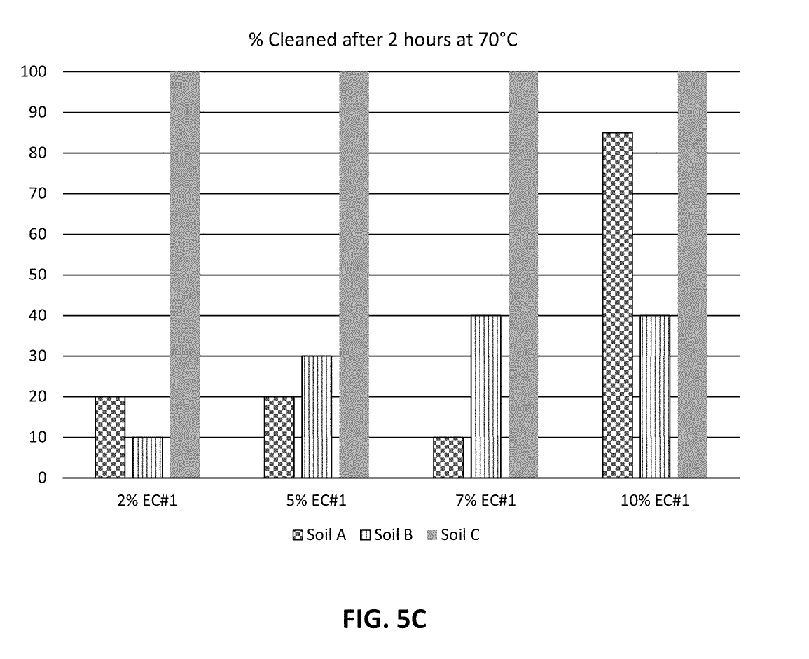

FIGS. 5A-5C show results for cleaning Soils A, B, and C with solutions having 2%, 5%, 7%, and 10% EC#1. Soil A was most effectively removed with the 10% EC#1 solution. While only 10% of soil was removed after 30 minutes, 85% of soil was removed after 2 hours. Less soil was removed at any time with the dilutions of less than 10% EC#1. The EC#1 dilution solutions were only effective at removing 40% of Soil B at best. This was achieved with 7% and 10% solutions of EC#1. All of the EC#1 dilution solutions were effective at removing 100% of Soil C after 1 hour (many after only 30 minutes).

### Example 3

Another study was conducted to test experimental cleaning compositions for removal of latex paint and latex paint components. Soils D-G were applied to stainless steel coupons in multiple layers as described above in Example 1. Two experimental compositions (#1 and #2) were compared with 20% NaOH treatment and Comparative Composition #2. Experimental composition #1 was used at 10% concentration, diluted with water.

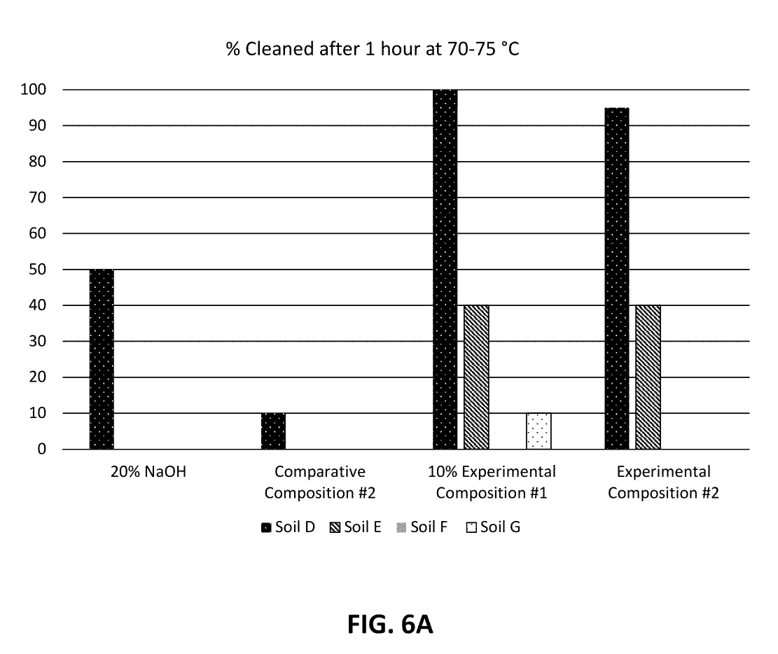

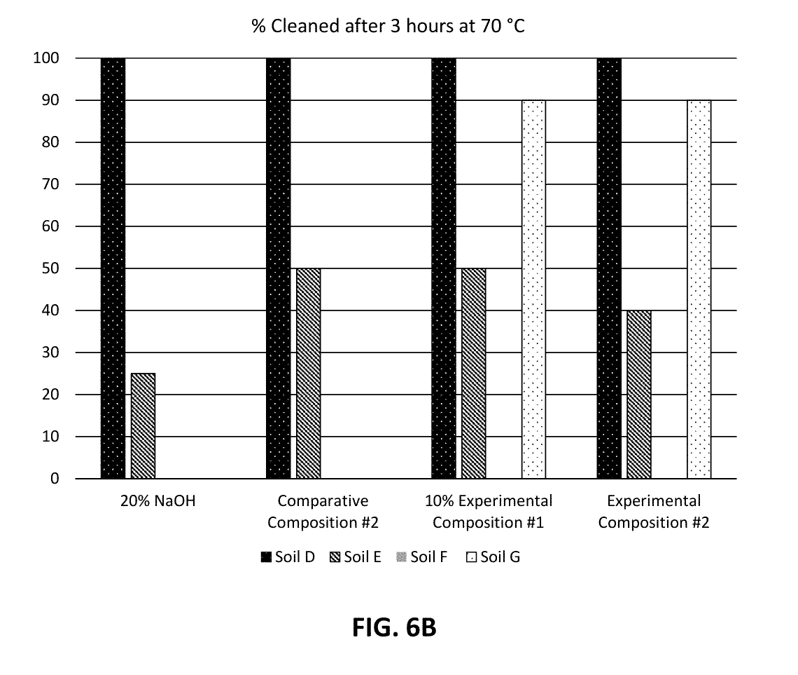

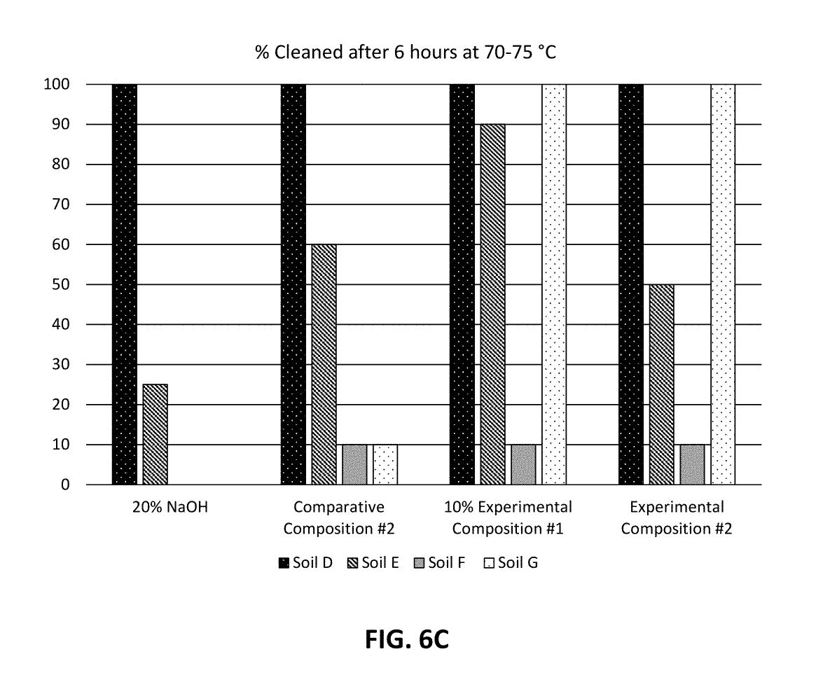

The results of this testing are depicted in the graphs of FIGS. 6A-6C. After 1 hour of cleaning with the compositions at a temperature of about 70-75° C., the experimental compositions showed the most effective cleaning, with the 10% Experimental Composition #1 removing all of Soil D, 40% of Soil E, and 10% of Soil G. Experimental Composition #2 removed 95% of Soil D and 40% of Soil E. The 20% NaOH composition cleaned 50% of Soil D, but was not effective in removing any of the other soils while Comparative Composition #2 was only able to remove 10% of Soil D after 1 hour of cleaning.

After 3 hours, all of the tested compositions had removed 100% of Soil D (FIG. 6B). None of the tested compositions were effective to remove any of Soil F. The 20% NaOH solution was effective at removing 25% of Soil E, but did not remove any of Soil F or Soil G. Comparative Composition #2 removed 50% of Soil E, but was also unsuccessful in removing Soil F and Soil G. The 10% solution of Experimental Composition #1 removed 50% of Soil E and 90% of Soil G. Experimental Composition #2 removed 40% of Soil E and 90% of Soil G. Overall, the experimental compositions performed similarly to comparative composition #2 with respect to removal of Soils D, E, and F. However, only Experimental Compositions #1 and #2 were successful in removing Soil G.

FIG. 6C shows the results for amount cleaned after 6 hours of treatment at 70-75° C. Treatment with 20% NaOH did not show any improvement over the 3 hour treatment time. Comparative Composition #2 was able to remove more of Soil E and was even successful in removing 10% of soils F and G after 6 hours. Both Experimental Compositions #1 and #2 were able to remove 100% of Soils D and G. Experimental Composition #1 removed 90% of Soil E while Experimental Composition #2 only removed 50%. Both experimental compositions were only able to remove 10% of Soil F after 6 hours. Overall, the 10% solution of Experimental Composition #1 removed the most soil of each type.

### Example 4

Various aqueous based emulsion polymers were applied to stainless steel coupons in layers (Soil H). The coupons were dipped in liquid soil, then allowed to dry at room temperature for 24 hours before dipping in a different liquid soil. A total of 6 layers of soil were applied to the coupons. The coupons were hung in use solutions using the apparatus described above and depicted in FIG. 1. Comparative Composition #2 and a 10% solution of Experimental Composition #1 were preheated to 70° and mixed at 300 rpm in a water bath over a heater/stirrer with 500 mL of chemistry in each beaker.

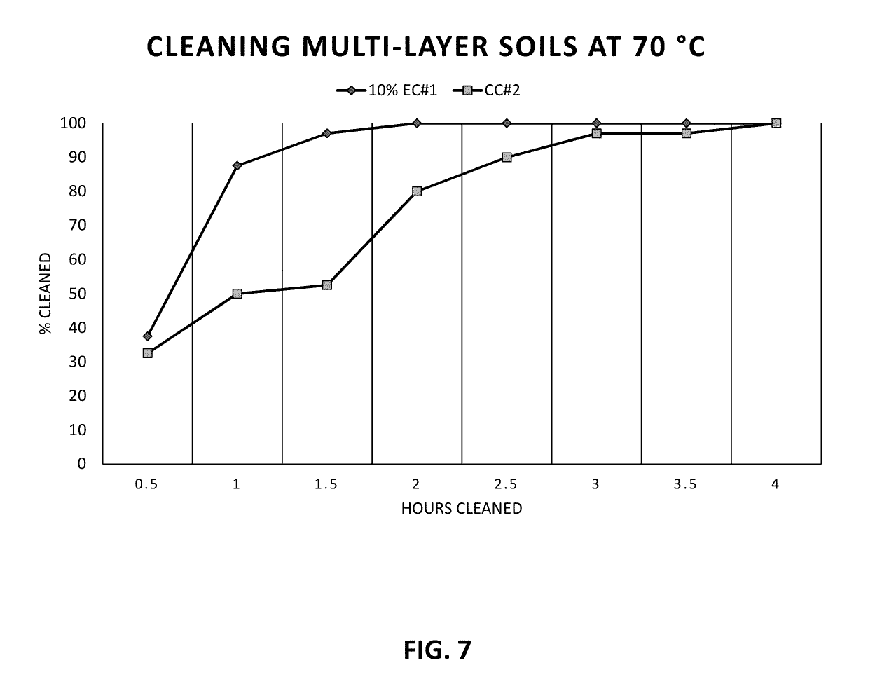

The results are displayed in FIG. 7. Compared to Comparative Composition #2, the 10% solution of Experimental Composition #1 removed the multi-layer soils more quickly. After an hour, EC#1 had removed almost 90% of soils while CC#2 had removed 50%. By 2 hours, EC#1 had completely removed the soils while CC#2 removed 80%. Eventually, at the 4 hour mark, CC#2 removed all of the soil. Overall, the 10% solution of Experimental Composition #1 removed the multi-layer polymer soils much more quickly than the Comparative Composition #2.

TABLE 3
Experimental Cleaning Compositions 3 and 4

| Experimental Composition | Experimental Composition |
|---|---|
| #3 (EC#3) | #4 (EC#4) |
| 52 wt. % deionized water | 31 wt. % soft water |
| 0.9 wt. % alkyl glucoside surfactant | 40 wt. % NaOH (50%) |
| 3.5 wt. % polyacrylic acid | 5 wt. % EDTA (38%) |
| 40 wt. % NaOH (50%) | 20 wt. % KOH (45% solution) |
| 1 wt. % KOH (45% solution) | 4 wt. % alkyl glucoside |
| | surfactant |
| 3 wt. % sodium glucoheptonate (50%) | |

### Example 5

Example 5 tested the ability of Experimental Compositions 3 and 4 at removing acrylic latex soil (Soil F). Stainless steel coupons were dipped once in Soil F and allowed to dry overnight at ambient temperature. Experimental Formulas 3 and 4 were diluted to 10% solutions in water in beakers, and preheated to 80° C. The beakers were placed on a hot plate with a stirbar set to 300 rpm. The coupons were placed into the cleaning solutions and the timer started. Table 4 shows the soil removal results over time as determined by a visual assessment.

TABLE 4

Percent Soil Removed

| | Experimental | Experimental |
|---|---|---|
| Time | Composition 3 | Composition 4 |
| 30 minutes | 90 | 95 |
| 60 minutes | 90 | 95 |
| 90 minutes | 95 | 99 |
| 120 minutes | 99 | 100 |

### Example 6

Example 6 compared Experimental Composition 4 and Experimental Composition 1 at removing Soil F. Stainless steel coupons were dipped in Soil F and allowed to dry overnight at ambient temperature. Experimental Compositions 1 and 4 were diluted to 10% solutions in beakers and heated to 80° C. The beakers were placed on a hot plate with a stirbar set to 300 rpm. The coupons were placed in the beaker and the timer started. The soil removal results are found in Table 5 as determined by visual assessment.

TABLE 5

Percent soil removal

| | Experimental | Experimental |
|---|---|---|
| Time | Composition 1 | Composition 4 |
| 30 minutes | 98 | 95 |
| 60 minutes | 100 | 100 |
| 90 minutes | 100 | 100 |
| 120 minutes | 100 | 100 |

While certain embodiments have been described, other embodiments may exist. While the specification includes a detailed description, the scope of the present disclosure is indicated by the following claims. The specific features and acts described above are disclosed as illustrative aspects and embodiments. Various other aspects, embodiments, modifications, and equivalents thereof which, after reading the description herein, may suggest themselves to one of ordinary skill in the art without departing from the spirit of the present disclosure or the scope of the claimed subject matter.

1. A method of cleaning residue from surfaces of paint production equipment, the method comprising:
diluting a concentrate composition with water to produce a cleaning composition, the concentrate composition comprising:
a) at least 30 wt-% organic solvent selected from the group consisting of aromatic alcohol, glycol ether, and mixtures thereof;
b) at least 8 wt-% alkanolamine;
c) alkalinity source;
d) surfactant;
e) no more than 50 wt-% water, wherein the cleaning composition has a pH of 10 or higher at the time of dilution;
heating the cleaning composition to a temperature of at least 55° C.; and
applying the cleaning composition to the surfaces of the paint production equipment.

2. The method of claim 1, wherein the cleaning composition is applied to the interior surfaces of the equipment using a clean-in-place technique.

3. The method of claim 1, in which the organic solvent is benzyl alcohol.

4. The method of claim 1, wherein the concentrate composition comprises at least 45 wt-% organic solvent.

5. The method of claim 1, wherein the concentrate composition comprises no more than 80 wt-% organic solvent.

6. The method of claim 1, wherein the alkanolamine is selected from the group consisting of monoethanolamine (MEA), diethanolamine (DEA), and mixtures thereof.

7. The method of claim 1, wherein the cleaning composition comprises up to 30 wt-% alkanolamine.

8. The method of claim 1, wherein the surfactant comprises anionic surfactant.

9. The method of claim 1, wherein the cleaning composition comprises at least 2 wt-% surfactant.

10. The method of claim 1, wherein the alkalinity source comprises alkali metal hydroxide.

11. The method of claim 1, wherein the cleaning composition has a pH of at least 13.

12. The method of claim 1, wherein the cleaning composition is heated to a temperature of no more than 90° C.

13. The method of claim 1, wherein the cleaning composition further comprises thickener.

14. The method of claim 1, wherein the cleaning composition is substantially free of fluorosurfactants.

15. The method of claim 1, wherein the cleaning composition comprises at least 1 wt-% alkalinity source.

16. The method of claim 1, wherein the concentrate composition further comprises at least 1 wt-% fatty acid.

17. The method of claim 1, wherein the concentrate composition comprises:
40 to 80 wt-% benzyl alcohol;
12 to 40 wt-% alkanolamine;
1.5 to 10 wt-% alkali metal hydroxide;
3 to 16 wt-% anionic surfactant;
2 to 7 wt-% fatty acid; and
water, wherein the pH of the concentrate composition is at least 13.

18. A method of cleaning residue from surfaces of paint production equipment, the method comprising:
diluting a concentrate composition with water to produce a cleaning composition, the concentrate composition comprising:
a) at least 0.1 wt-% chelating agent;
b) alkalinity source;
c) surfactant; and
d) no more than 50 wt-% water, wherein the cleaning composition has a pH of 10 or higher at the time of dilution;
heating the cleaning composition to a temperature of at least 55° C.; and
applying the cleaning composition to the surfaces of the paint production equipment.

19. The method of claim 18, wherein the cleaning composition is applied to the interior surfaces of the equipment using a clean-in-place technique.

20. The method of claim 18, wherein the chelating agent is selected from the group consisting of ethylenediaminetetraacetic acid (EDTA), sodium glucoheptanoate, polyacrylic acid, and mixtures thereof.

21. The method of claim 18, wherein the cleaning composition comprises up to 20 wt-% chelating agent.

22. The method of claim 18, wherein the surfactant comprises nonionic surfactant.

23. The method of claim 18, wherein the cleaning composition comprises at least 0.5 wt-% surfactant.

24. The method of claim 18, wherein the alkalinity source comprises alkali metal hydroxide.

25. The method of claim 18, wherein the cleaning composition has a pH of at least 13.

26. The method of claim 18, wherein the cleaning composition is heated to a temperature of no more than 90° C.

27. The method of claim 18, wherein the cleaning composition is substantially free of fluorosurfactants.

28. The method of claim 18, wherein the cleaning composition comprises at least 1 wt-% alkalinity source.

29. The method of claim 18, wherein the cleaning composition is free of organic solvent.

30. The method of claim 18, wherein the concentrate composition comprises:
0.1 to 20 wt-% chelating agent;
1.5 to 30 wt-% alkali metal hydroxide;
0.5 to 20 wt-% nonionic surfactant; and
water, wherein the pH of the concentrate composition is at least 13.
